(19) United States
(12) Patent Application Publication
(10) Pub. No.: US 2005/0278490 A1
(43) Pub. Date: Dec. 15, 2005

(54) Memory access control apparatus and method of controlling memory access

(75) Inventor: Kohei Murayama, Koto-ku (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/146,946

(22) Filed: Jun. 7, 2005

(30) Foreign Application Priority Data
Jun. 10, 2004 (JP) 2004-172703

(51) Int. Cl. G06F 12/00

(52) U.S. Cl. 711/154

(57) ABSTRACT

A memory interface circuit controls a memory device that inputs and outputs data in response to data strobe signals. The memory interface circuit includes an at-input selection unit selecting a data strobe signal to be received at the time of inputting the data based on information concerning the number of data strobe signals specified for the data and a data capturing unit capturing the data based on the data strobe signal selected in the at-input selection unit, thereby allowing the same circuit to control memory devices which use different types of data strobe signals.

### BACKGROUND OF THE INVENTION

1. Field of the Invention

The present invention relates to a memory interface circuit controlling a memory device that inputs and outputs data in response to data strobe signals and to an interface method of controlling the memory device.

2. Description of the Related Art

In recent years, memory devices, such as a double data rate (DDR) synchronous dynamic random access memory (SDRAM), which input and output data in response to data strobe signals defined for the data in addition to clocks defined for the memories, have come into common use as the memory devices realizing high bandwidth (for example, refer to Japanese Patent Laid-Open No. 2003-15953).

The input and output operation of the data between the controller that controls a memory device, such as the DDR-SDRAM, and the memory device is performed in the following manner. When the data is output from the controller to the memory device, the controller generates data strobe signals having phase delays with respect to the output data in, for example, a delay circuit therein, and the memory device captures data at rising edges and falling edges of the data strobe signals.

When the data is input to the controller, the memory device outputs the data strobe signals along with the data, and the controller delays the phases of the data strobe signals in, for example, the delay circuit to generate new data strobe signals and captures the data at rising edges and falling edges of the generated data strobe signals. The definition of the corresponding data strobe signal for the data allows the data to be input and output based on the relative association between the data and the data strobe signal.

However, there are cases in which different numbers of data strobe signals are used for the data in different applications of the memory device. Generally, in a product family of, for example, computers, which family requires a large amount of memory, the DDR-SDRAM connected to a memory slot often performs the control in which one data strobe signal is used for eight-bit data. In contrast, a memory device for graphical use, which device is directly mounted on a board and requires a small amount of memory, performs the control in which one data strobe signal is used for 32-bit data.

The use of multiple DDR-SDRAM devices connected to the memory slot ensures the memory data bus width, whereas the use of a small number of DDR-SDRAM devices for graphical use ensures the memory data bus width because the memory data bus of the DDR-SDRAM itself is wide.

The DDR-SDRAM device used in, for example, a dual inline memory module (DIMM) has a data bus width of eight bits or 16 bits. For example, the use of eight (or four) devices, as in a system shown in FIG. 6, realizes the 64-bit-width data bus through which a large scale integrated circuit (LSI) 100 is connected to memory devices 101 to 108. In contrast, the DDR-SDRAM device for graphical use has a data bus width of 32 bits. The use of two devices, as in a system shown in FIG. 7, realizes the 64-bit-width data bus through which an LSI 200 is connected to memory devices 201 and 202.

As described above, in the product family requiring a large amount of memory, the use of multiple devices that use the DIMM connected to the memory slot and have a small data bus width achieves the data bus width and realizes the large memory system. In contrast, in the product family that does not require a large amount of memory, it is necessary to achieve the memory data bus width with a smaller number of memory devices because reduction in the cost of the memory device and in the area of the board is useful for cost reduction of the product.

Generally, when the usage of the memory device is defined, the memory is accessed by using a memory control circuit corresponding to the usage of the memory device. Accordingly, the control of the memory device used in the DIMM or the like is necessary in the system requiring a large amount of memory, whereas the control of the memory device for graphical use is necessary in the system that does not require a large amount of memory. The memory device used in the DIMM or the like differs from the memory device for graphical use in the number of data strobe signals and the correspondence between the data and the data strobe signal.

For example, when the DDR-SDRAM device used in the DIMM or the like is to be controlled, eight data strobe signals are required for 64 bits. When the DDR-SDRAM device for graphical use is to be controlled, two data strobe signals are required for 64 bits.

As described above, since the correspondence between the data and the data strobe signal and the number of data strobe signals in the control of the DDR-SDRAM. device used in the DIMM or the like are different from those in the control of the DDR-SDRAM device for graphical use, it is difficult to use a common interface mechanism.

For example, when the eight data strobe signals are provided for the 64-bit data as an LSI interface in the DDR-SDRAM device for graphical use, it is necessary to realize, on the board, a configuration in which the two data strobe signals are combined with the eight data strobe signals.

Specifically, in a configuration having an LSI 300 connected to DDR-SDRAM devices 301 and 302 for graphical use in FIG. 8, a pin DQS of the DDR-SDRAM device 301 is connected to pins DQS0, DQS1, DQS2, and DQS3 of the LSI 300 and a pin DQS of the DDR-SDRAM device 302 is connected to pins DQS4, DQS5, DQS6, and DQS7 of the LSI 300 on the board to realize the configuration in which the two data strobe signals are combined with the eight data strobe signals on the board.

In the configuration in FIG. 8, when data is output from the LSI 300 to the DDR-SDRAM devices 301 and 302, the data-strobe-signal input pins of the DDR-SDRAM devices 301 and 302 have high impedance and four outputs from the LSI 300 come into collision with each other. Even when the four outputs are logically driven at the same timing, signals having different polarities come into collision with each other to cause problems including durability because a data strobe signal is in a “high” level while another data strobe signals is in a “low” level in consideration of the delay in the LSI 300 and the delay on the board.

When data is input from the DDR-SDRAM devices 301 and 302 to the LSI 300, the DDR-SDRAM devices 301 and 302 drive the data simultaneously with the data strobe signals. However, it is difficult to ensure the relative phase and the wiring pattern on the board becomes complicated because the load of the data strobe signals is four times that of the data.

In contrast, when the two data strobe signals are provided for the 64-bit data as an LSI interface in the DDR-SDRAM device used in the DIMM, it is necessary to realize on the board a configuration in which the two data strobe signals are divided among the eight data strobe signals in a pattern reverse to the above configuration.

Specifically, in a configuration in which an LSI 400 is connected to DDR-SDRAM devices 401 to 408 used in the DIMM shown in FIG. 9, pins DQS of the DDR-SDRAM devices 401 to 404 are connected to a pin DQS1 of the LSI 400 and pins DQS of the DDR-SDRAM devices 405 to 408 are connected to a pin DQS0 of the LSI 400 on the board to realize the configuration in which the two data strobe signals are divided among the eight data strobe signals on the board.

In the configuration in FIG. 9, when data is output from the LSI 400 to the DDR-SDRAM devices 401 to 408, the two data strobe signals are divided among the eight data strobe signals. Hence, it is difficult to ensure the relative phase and the wiring pattern on the board becomes complicated because the load of the data is different from that of the data strobe signals.

Since it is not possible to control the memory devices using different types of data strobe signals by using the same LSI for the above reason, different memory interface circuits corresponding to the memory devices have been used hitherto.

### SUMMARY OF THE INVENTION

The present invention provides a memory interface circuit capable of controlling memory devices having different kinds of data strobe signals by using the same LSI and an interface method of controlling the memory device.

The present invention further provides a memory interface circuit capable of producing timing design on a board by making the load of data strobe signals equal to that of data and an interface method.

The present invention provides, in a first aspect, a memory interface circuit controlling a memory device that inputs and outputs data in response to data strobe signals. The memory interface circuit includes an at-input selection unit selecting a data strobe signal to be received at the time of inputting the data based on information concerning the number of data strobe signals specified for the data and a data capturing unit capturing the data based on the data strobe signal selected in the at-input selection unit.

The present invention provides, in a second aspect, a memory interface circuit controlling a memory device that inputs and outputs data in response to data strobe signals. The memory interface circuit includes an at-output selection unit selecting a data strobe signal to be output at the time of outputting the data based on information concerning the number of data strobe signals specified for the data and an output setting unit setting the output of the data strobe signal that is not selected by the at-output selection unit to a high-impedance state.

The present invention provides, in a third aspect, an interface method of controlling a memory device that inputs and outputs data in response to data strobe signals. The interface method includes specifying the number of data strobe signals for the data, selecting a data strobe signal to be input at the time of inputting the data based on the specified number of data strobe signals, and capturing the data based on the selected data strobe signal.

The present invention provides, in a fourth aspect, an interface method of controlling a memory device that inputs and outputs data in response to data strobe signals. The interface method includes specifying the number of data strobe signals for the data, selecting a data strobe signal to be output at the time of outputting the data based on the specified number of data strobe signals, and setting the output of the data strobe signal that is not selected to a high-impedance state.

Further features and advantages of the present invention will become apparent from the following description of exemplary embodiments with reference to the attached drawings.

### BRIEF DESCRIPTION OF THE DRAWINGS

FIG. 1 is a circuit diagram showing the configuration of a memory interface circuit according to a first embodiment of the present invention.

FIG. 2 shows a correspondence table between data and data strobe signals in the configuration in FIG. 1.

FIG. 3 is a circuit diagram showing an example of the configuration of a memory interface circuit in a related art.

FIG. 4 is a circuit diagram showing the configuration of a memory interface circuit according to a second embodiment of the present invention.

FIG. 5 shows a correspondence table between data and data strobe signals in the configuration in FIG. 4.

FIG. 6 shows a first configuration example of connection between an LSI and memory devices in a related art.

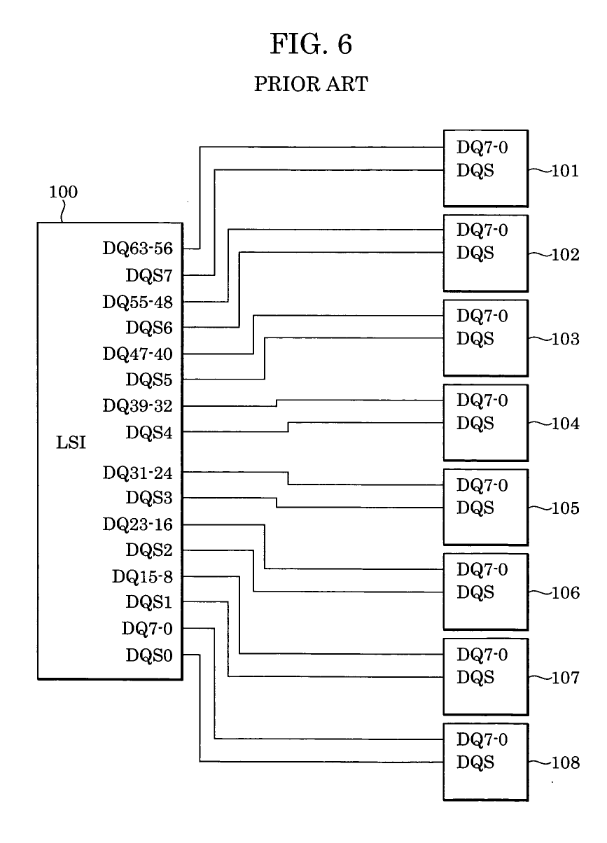

FIG. 7 shows a second configuration example of connection between an LSI and memory devices in a related art.

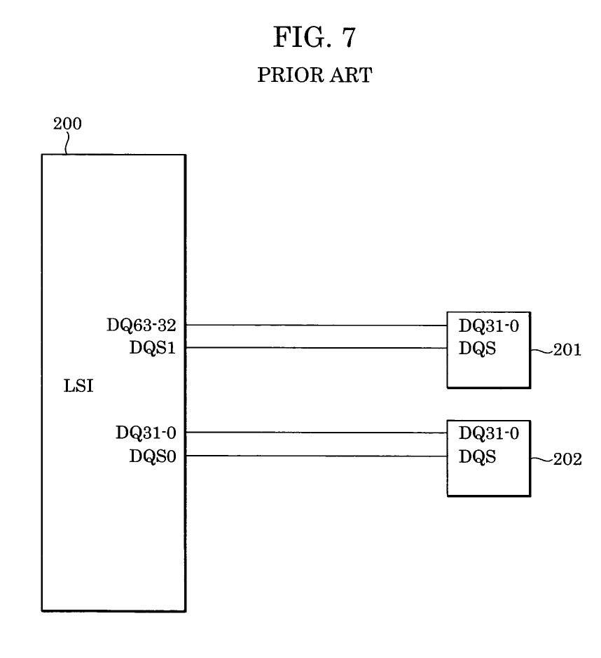

FIG. 8 shows a third configuration example of connection between an LSI and memory devices in a related art.

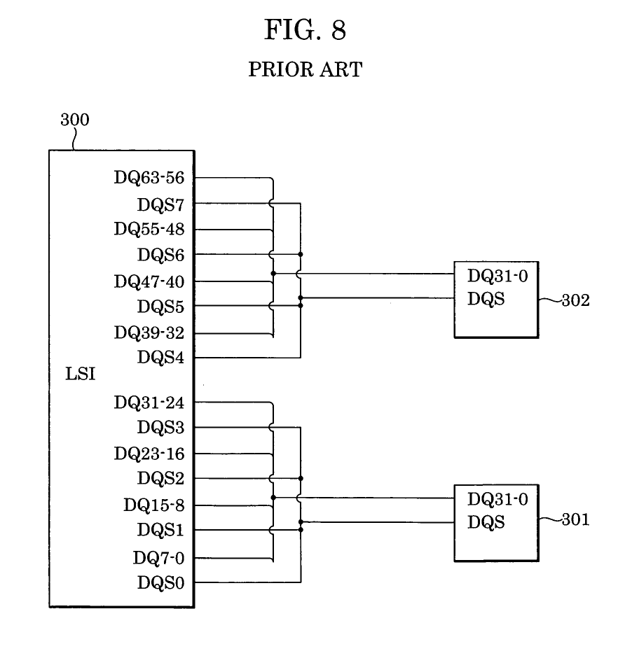

FIG. 9 shows a fourth configuration example of connection between an LSI and memory devices in a related art.

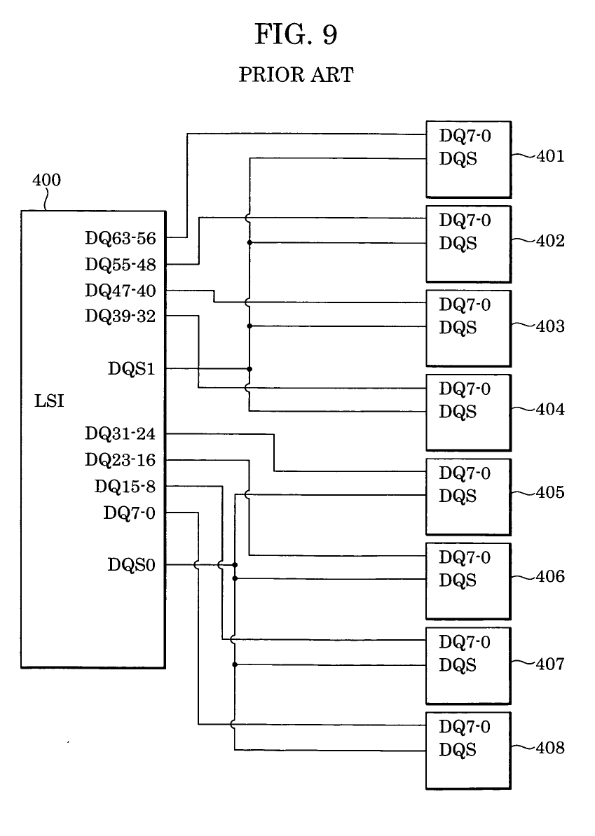

### DESCRIPTION OF THE EMBODIMENTS

Embodiments of the present invention will be described in detail below with reference to the attached drawings.

### FIRST EMBODIMENT

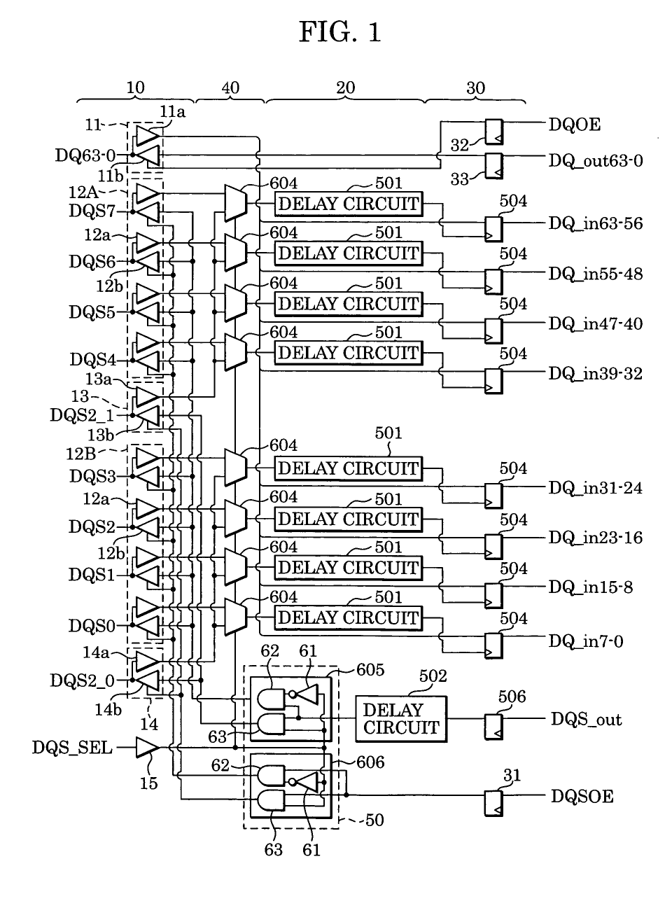

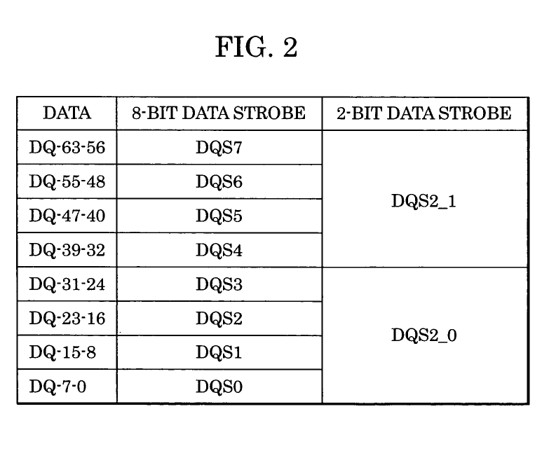

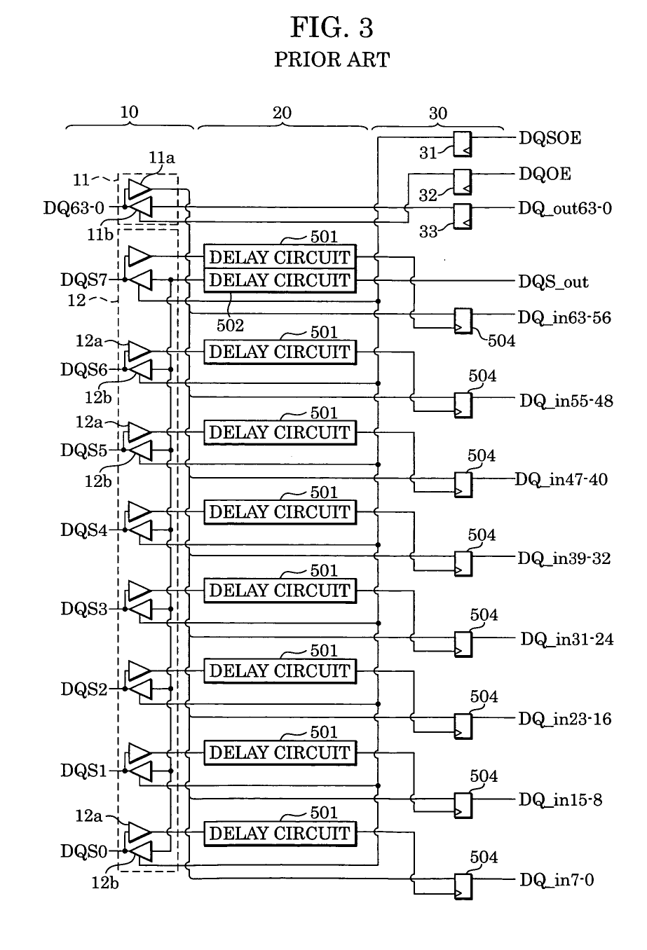

FIG. 1 is a circuit diagram showing the configuration of a memory interface circuit according to a first embodiment of the present invention. FIG. 2 shows a correspondence table between data and data strobe signals in the configuration in FIG. 1. FIG. 3 is a circuit diagram showing an example of the configuration of a memory interface circuit in a related art.

Example of Configuration of Memory Interface Circuit in Related Art

An example of the configuration of a memory interface circuit in a related art, which configuration the present invention is based on, will now be described with reference to FIG. 3.

A memory interface circuit in FIG. 3 is provided in, for example, an LSI, and is structured so as to use eight data strobe signals for 64-bit data bus width to control access to, for example, a DDR-SDRAM, which is a memory device outside the LSI. The memory interface circuit includes an input-output circuit unit 10, a delay circuit unit 20, and a flip-flop circuit unit 30.

The input-output circuit unit 10 includes an input-output circuit 11 to and from which 64-bit data DQ63-0 is input and output and an input-output circuit 12 to and from which eight data strobe signals are input and output. The input-output circuit 11 includes an input buffer 11a to which the 64-bit data DQ63-0 is input from the DDR-SDRAM and an output buffer 11b from which the 64-bit data DQ63-0 is output to the DDR-SDRAM. The input-output circuit 12 includes eight input buffers 12a to which eight data strobe signals DQS7 to DQS0 are respectively input from the DDR-SDRAM and eight output buffers 12b from which the eight data strobe signals DQS7 to DQS0 are respectively output to the DDR-SDRAM.

The output buffers 11b and 12b are tri-state buffers whose output states are controlled by control signals. Specifically, the output states of the output buffers 11b and 12b are controlled with a data output control signal DQOE and a data-strobe output control signal DQSOE described below, respectively. According to the first embodiment, the signals are driven at a “high” level and the signals are in a high-impedance state in a “low” level.

The delay circuit unit 20 includes eight delay circuits 501 that delay the data strobe signals DQS7 to DQS0 input through the eight respective input buffers 12a and a delay circuit 502 that delays a data strobe signal DQS_out. The output port of the delay circuit 502 is commonly connected to the input ports of the output buffers 12b.

The flip-flop circuit unit 30 includes flip-flops 31 to 33 and eight flip-flops 504. The flip-flop 31 outputs the data-strobe output control signal DQSOE to the output buffers 12b in the input-output circuit 12 at a predetermined timing. The flip-flop 32 outputs the data output control signal DQOE to the output buffer 11b in the input-output circuit 11 at a predetermined timing. The flip-flop 33 outputs 64-bit output data DQ_out63-0 that is to be transmitted to the DDR-SDRAM through the output buffer 11b at a predetermined timing. The eight flip-flops 504 capture data corresponding to the data strobe signals DQS7 to DQS0, among 64-bit input data DQ63-0 input from the DDR-SDRAM through the output buffers 11a.

The eight data strobe signals DQS7 to DQS0 input through the respective input buffers 12a in the input-output circuit 12 are delayed by the respective delay circuits 501 and are supplied to the clock pins of the flip-flops 504 for capturing the corresponding data.

In the correspondence between the input data and the eight data strobe signals, shown in FIG. 2, data DQ63-56 corresponds to the data strobe signal DQS7, data DQ55-48 corresponds to the data strobe signal DQS6, data DQ47-40 corresponds to the data strobe signal DQS5, data DQ39-32 corresponds to the data strobe signal DQS4, data DQ31-24 corresponds to the data strobe signal DQS3, data DQ23-16 corresponds to the data strobe signal DQS2, data DQ15-8 corresponds to the data strobe signal DQS1, and data DQ7-0 corresponds to the data strobe signal DQS0.

When the 64-bit output data DQ_out63-0 is output to the DDR-SDRAM, the memory interface circuit having the above configuration outputs the output data DQ_out63-0 from the output buffer 11b to the DDR-SDRAM with the data output control signal DQOE being set to the “high” level. Simultaneously, the memory interface circuit outputs the data strobe signals DQS7 to DQS0, produced by delaying the data strobe signal DQS_out by the delay circuit 502, from the eight output buffers 12b to the DDR-SDRAM with the data-strobe output control signal DQSOE being set to the “high” level.

When the 64-bit data DQ63-0 is received from the DDR-SDRAM, the memory interface circuit receives the data DQ63-0 through the input buffer 11a and, simultaneously, receives the data strobe signals DQS7 to DQS0 through the eight input buffers 12a. The data strobe signals DQS7 to DQS0 are delayed in the eight delay circuits 501 and are supplied to the clock pins of the eight flip-flops 504.

As a result, the data DQ63-0 input through the input buffer 11a is divided into input data DQ_in 63-56, DQ_in 55-48, . . . , DQ_in 7-0 in accordance with the clock timing of the data strobe signals DQS7 to DQS0 and is supplied to the corresponding flip-flops 504.

Memory Interface Circuit According to First Embodiment

The memory interface circuit according to the first embodiment, which is provided by applying the present invention to the known memory interface circuit described above, will now be described with reference to FIG. 1. The same reference numerals are used in FIG. 1 to identify the same elements shown in FIG. 3. A detailed description of such elements is omitted here.

The memory interface circuit according to the first embodiment, shown in FIG. 1, has a structure capable of being connected to both the DDR-SDRAM requiring eight data strobe signals for 64-bit data bus width and the DDR-SDRAM requiring two data strobe signals for the 64-bit data bus width.

Specifically, the memory interface circuit according to the first embodiment differs from the memory interface circuit in FIG. 3 in that the configuration of the input-output circuit unit 10 is altered and a selector circuit unit 40 and a gate circuit unit 50 are added.

The input-output circuit unit 10 includes input-output circuits 12A and 12B corresponding to one group of data strobe signals DQS7 to DQS0 and input-output circuits 13 and 14 corresponding to another group of data strobe signals DQS2_1 and DQS2_0. The input-output circuits 12A and 12B arranged corresponding to the group of the data strobe signals DQS7 to DQS0 correspond to the input-output circuit 12 in FIG. 3. The input-output circuits 13 and 14 arranged corresponding to the group of the data strobe signals DQS2_1 and DQS2_0 have input buffers 13a and 14a and output buffers 13b and 14b, respectively.

The group of the data strobe signals DQS7 to DQS0 supports the DDR-SDRAM requiring the eight data strobe signals. The group of the data strobe signals DQS2_1 and DQS2_0 supports the DDR-SDRAM requiring the two data strobe signals.

The group of the data strobe signals DQS7 to DQS0 and the group of the data strobe signals DQS2_1 and DQS2_0 correspond to the data DQ63-0 in a manner shown in FIG. 2. Namely, as described above, the group of the data strobe signals DQS7 to DQS0 corresponds to the data DQ63-0 in the eight-bit data strobe item and the data strobe signals DQS2_1 and DQS2_0 correspond to the data DQ31-0 and the data DQ63-32, respectively, in the two-bit data strobe item.

The selector circuit unit 40 includes eight selectors 604 corresponding to the data strobe signals DQS7 to DQS0. Among the eight selectors 604, the four selectors 604 corresponding to the data strobe signals DQS7 to DQS4 each select either the output from the corresponding input buffer 12a in the input-output circuit 12A or the output from the input buffer 13a in the input-output circuit 13 in accordance with a data strobe selection signal DQS_SEL input through a buffer 15.

The data strobe selection signal DQS_SEL is a control signal for specifying the number of data strobe signals and is set at an input port receiving the data outside the LSI in accordance with the type of the used memory device by using, for example, a DIP switch. Although the data strobe selection signal DQS_SEL has an arbitrary polarity, the two data strobe signals are required when the data strobe selection signal DQS_SEL is set to the “high” level and the eight data strobe signals are required when the data strobe selection signal DQS_SEL is set to the “low” level, according to the first embodiment.

Each of the selectors 604 is controlled so as to output the data strobe signals DQS2_1 and DQS2_0 input through the input-output circuits 13 and 14 when the data strobe selection signal DQS_SEL is set to the “high” level and to output the data strobe signals DQS7 to DQS0 input through the input-output circuits 12A and 12B when the data strobe selection signal DQS_SEL is set to the “low” level.

The gate circuit unit 50 includes a gate circuit 605 for the data strobe signal DQS_out and a gate circuit 606 for the data-strobe output control signal DQSOE. The gate circuit 605 includes an inverter 61 and two AND gates 62 and 63. The AND gate 62 performs an AND operation for the data strobe signal DQS_out transmitted through the delay circuit 502 and the data strobe selection signal DQS_SEL transmitted through the inverter 61. The output from the AND gate 62 is supplied to the output buffers 12b in the input-output circuits 12A and 12B. The AND gate 63 performs an AND operation for the data strobe signal DQS_out transmitted through the delay circuit 502 and the data strobe selection signal DQS_SEL. The output from the AND gate 63 is supplied to the output buffers 13b and 14b in the input-output circuits 13 and 14, respectively.

The gate circuit 606 has the same configuration as the gate circuit 605. The data-strobe output control signal DQSOE and the data strobe selection signal DQS_SEL are supplied to the gate circuit 606. The output from the AND gate 62 in the gate circuit 606 serves as the control signal for the output buffers 12b in the input-output circuits 12A and 12B, and the output from the AND gate 63 in the gate circuit 606 serves as the control signal for the output buffers 13b and 14b in the input-output circuits 13 and 14. Data Input Operation

When the two data strobe signals are supplied from the DDR-SDRAM, the data strobe selection signal DQS_SEL is set to the “high” level. As a result, each of the selectors 604 selects only the data strobe signal DQS2_1 or DQS2_0 output from the input buffer 13a or 14a in the input-output circuit 13 or 14, respectively, and outputs the selected signal to the delay circuit 501.

In contrast, when the eight data strobe signals are supplied from the DDR-SDRAM, the data strobe selection signal DQS_SEL is set to the “low” state. As a result, each of the selectors 604 selects only one of the data strobe signals DQS7 to DQS0 output from the corresponding input buffer 12a in the input-output circuit 12A or 12B and outputs the selected signal to the delay circuit 501.

Data Output Operation

When the two data strobe signals are supplied from the DDR-SDRAM, the data strobe selection signal DQS_SEL is set to the “high” level and is supplied to the gate circuit 605 for the data strobe signal DQS_out and the gate circuit 606 for the data-strobe output control signal DQSOE.

Since the data strobe selection signal DQS_SEL is set to the “high” level in the gate circuit 605, the output from the AND gate 62 is fixed to the “low” level. In other words, the output of the data strobe signal DQS_out to the input-output circuits 12A and 12B for the data strobe signals DQS7 to DQS0 is gated, and the data strobe signal DQS_out is supplied only to the input-output circuits 13 and 14 for the data strobe signals DQS2_1 and DQS2_0 through the AND gate 63.

Since the data strobe selection signal DQS_SEL is set to the “high” level in the gate circuit 606, as in the gate circuit 605, the output from the AND gate 62 is fixed to the “low” level. Accordingly, the data-strobe output control signal DQSOE is driven for the input-output circuits 13 and 14 for the data strobe signals DQS2_1 and DQS2_0, and the outputs to the output buffers 12b in the input-output circuits 12A and 12B are controlled so as to be in a high-impedance state.

In contrast, when the eight data strobe signals are supplied from the DDR-SDRAM, the data strobe selection signal DQS_SEL is set to the “low” level and, therefore, the reverse logic is applied, compared with the case in which the two data strobe signals are supplied from the DDR-SDRAM. Specifically, the outputs from the AND gates 63 in the gate circuits 605 and 606 are fixed to the “low” level. As a result, only the input-output circuits 12A and 12B for the group of the data strobe signals DQS7 to DQS0 are driven, and the outputs to the output buffers 13b and 14b in the input-output circuits 13 and 14 for the group of the data strobe signals DQS2_1 and DQS2_0 are controlled so as to be in a high-impedance state.

As described above, even when the memory interface circuit according to the first embodiment is connected to the memory devices having different number of data strobe signals, it is possible to correctly transmit and receive the data strobe signals depending on the connected memory device, thus being capable of avoiding the collision of the data strobe signals on the board. In addition, since the memory interface circuit according to the first embodiment is structured such that the data strobe signals have the same load as the data, simple timing design can be realized on the board. Accordingly, it is possible to control different types of memory devices using the same memory interface circuit.

### SECOND EMBODIMENT

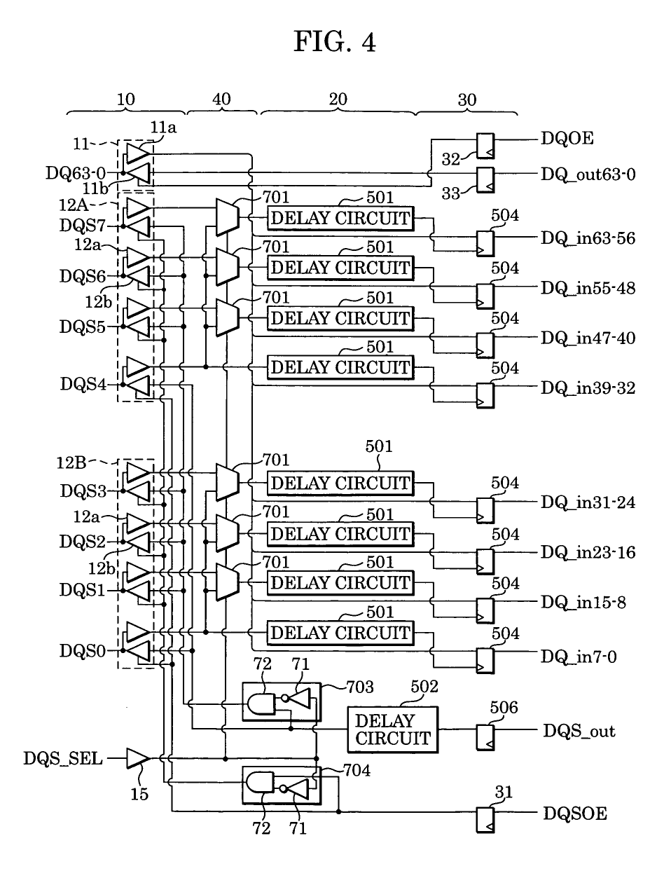

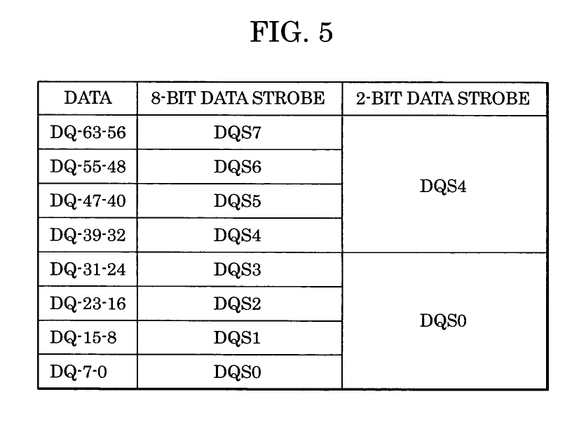

FIG. 4 is a circuit diagram showing the configuration of a memory interface circuit according to a second embodiment of the present invention. FIG. 5 shows a correspondence table between data and data strobe signals in the configuration in FIG. 4. The same reference numerals are used in FIG. 4 to identify the same elements shown in FIG. 1. A detailed description of such elements is omitted here.

The memory interface circuit in FIG. 4 uses eight data strobe signals for 64-bit data bus width. The memory interface circuit is structured so as to share part of the data strobe signals between when the two data strobe signals are used and when the eight data strobe signals are used. Specifically, in the configuration of the memory interface circuit according to the second embodiment, the input buffer 12a and the output buffer 12b for the data strobe signal DQS4 in the input-output circuit 12A and the input buffer 12a and the output buffer 12b for the data strobe signal DQS0 in the input-output circuit 12B are used in both the case in which the memory device using the two data strobe signals is connected to the memory interface circuit and the case in which the memory device using the eight data strobe signals is connected to the memory interface circuit. The input buffers 12a and the output buffers 12b for the remaining data strobe signals DQS7 to DQS5 and DQS3 to DQS1 are used only for the memory device using the eight data strobe signals.

The correspondence between the data DQ63-0, the data strobe signals DQS7 to DQS0 when the eight data strobe signals are used (eight bits), and the data strobe signals DQS4 and DQS0 when the two data strobe signals are used (two bits) is shown in FIG. 5.

The difference between the configuration according to the second embodiment and the configuration according to the first embodiment will now be specifically described.

The polarities of the data strobe selection signal DQS_SEL and the data-strobe output control signal DQSOE are the same as in the configuration shown in FIG. 1. The data strobe signals DQS7 to DQS5 through the input buffers 12a are supplied to the delay circuits 501 through the three corresponding selectors 701, and the data strobe signals DQS3 to DQS1 through the input buffers 12a are supplied to the delay circuits 501 through the three corresponding selectors 701.

The data strobe signal DQS4 is also supplied to the three selectors 701 corresponding to the input-output circuit 12A through the input buffer 12a for the data strobe signal DQS4. The data strobe signal DQS0 is also supplied to the three selectors 701 corresponding to the input-output circuit 12B through the input buffer 12a for the data strobe signal DQS0.

In other words, the three selectors 701 corresponding to the input-output circuit 12A and the three selectors 701 corresponding to the input-output circuit 12B select the data strobe signal DQS4 and the data strobe signal DQS0, respectively, when the data strobe selection signal DQS_SEL is set to the “high” level, and select the data strobe signals DQS7 to DQS5 and the data strobe signals DQS3 to DQS1, respectively, when the data strobe selection signal DQS_SEL is set to the “low” level.

The data strobe signals DQS4 and DQS0 are supplied to the corresponding delay circuits 501 through no selector.

In the circuit configuration described above, at the time of inputting the data DQ63-0, the data strobe signals DQS4 and DQS0 are used as the data strobe signals for the input data DQ63-0 when the data strobe selection signal DQS_SEL is set to the “high” level, whereas the data strobe signals DQS7 to DQS0 are used as the data strobe signals for the input data DQ_in63-56 to DQ_in7-0 when the data strobe selection signal DQS_SEL is set to the “low” level.

In contrast, at the time of outputting the data DQ_out63-0, the data strobe signals DQS4 and DQS0 are controlled so as to always be driven because both the data strobe signal DQS_out and the data-strobe output control signal DQSOE are transmitted not through gate circuits 703 and 704, respectively. With respect to the remaining the data strobe signals DQS7 to DQS5 and DQS3 to DQS1, the outputs from the gate circuits 703 and 704 are gated depending on the data strobe selection signal DQS_SEL.

Specifically, when the data strobe selection signal DQS_SEL is set to the high level, the outputs from the AND gates 72 in the gate circuits 703 and 704 are fixed to the “low” level. In other words, the outputs from the gate circuits 703 and 704 are gated and the outputs to the output buffers 12b for the data strobe signals DQS7 to DQS5 and DQS3 to DQS1 are controlled so as to be in a high-impedance state. When the data strobe selection signal DQS_SEL is set to the “low” level, the gate circuits 703 and 704 release the gate. As a result, the data strobe signals DQS7 to DQS5 and DQS3 to DQS1 are driven, in addition to the data strobe signals DQS4 and DQS0.

Since the memory interface circuit according to the second embodiment is structured such that the input buffers 12a and the output buffers 12b for the data strobe signals DQS4 and DQS0 are shared, a simpler circuit configuration can be realized, compared with the first embodiment.

According to the embodiments described above, it is possible to control the memory devices having different kinds of data strobe signals by using the same LSI.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-172703 filed Jun. 10, 2004, which is hereby incorporated by reference herein.

1. A memory interface circuit controlling a memory device that inputs and outputs data in response to data strobe signals, the memory interface circuit comprising:
an at-input selection unit selecting a data strobe signal to be received at the time of inputting the data based on information concerning the number of data strobe signals specified for the data; and
a data capturing unit capturing the data based on the data strobe signal selected in the at-input selection unit.

2. The memory interface circuit according to claim 1,
wherein the data strobe signal selected by the at-input selection unit includes a predetermined data strobe signal not based on the information concerning the number of data strobe signals.

3. The memory interface circuit according to claim 1,
wherein the information concerning the number of data strobe signals specifies a first number or a second number of data strobe signals,
wherein the second number is greater than the first number, and
wherein the at-input selection unit selects the first number of data strobe signals when the first number is specified, and selects the second number of data strobe signals when the second number is specified.

4. A memory interface circuit controlling a memory device that inputs and outputs data in response to data strobe signals, the memory interface circuit comprising:
an at-output selection unit selecting a data strobe signal to be output at the time of outputting the data based on information concerning the number of data strobe signals specified for the data; and
an output setting unit setting the output of the data strobe signal that is not selected by the at-output selection unit to a high-impedance state.

5. The memory interface circuit according to claim 4,
wherein the data strobe signal selected by the at-output selection unit includes a predetermined data strobe signal not based on the information concerning the number of data strobe signals.

6. The memory interface circuit according to claim 4,
wherein the information concerning the number of data strobe signals specifies a first number or a second number of data strobe signals,
wherein the second number is greater than the first number, and
wherein the at-output selection unit selects the first number of data strobe signals when the first number is specified, and selects the second number of data strobe signals when the second number is specified.

7. An interface method of controlling a memory device that inputs and outputs data in response to data strobe signals, the interface method comprising:
specifying the number of data strobe signals for the data;
selecting a data strobe signal to be input at the time of inputting the data based on the specified number of data strobe signals; and
capturing the data based on the selected data strobe signal.

8. The interface method according to claim 7,
wherein the selected data strobe signal includes a predetermined data strobe signal not based on the specified number of data strobe signals.

9. The interface method according to claim 7,
wherein the specified number of data strobe signals is a first number or a second number,
wherein the second number is greater than the first number, and
wherein the first number is selected when the first number is specified, and the second number is selected when the second number is specified.

10. Computer-executable process steps for causing a computer to execute the interface method of claim 7.

11. A computer-readable storage medium for storing the computer-executable process steps of claim 10.

12. An interface method of controlling a memory device that inputs and outputs data in response to data strobe signals, the interface method comprising:
specifying the number of data strobe signals for the data;
selecting a data strobe signal to be output at the time of outputting the data based on the specified number of data strobe signals; and
setting the output of the data strobe signal that is not selected to a high-impedance state.

13. The interface method according to claim 12,
wherein the selected data strobe signal includes a predetermined data strobe signal not based on the specified number of data strobe signals.

14. The interface method according to claim 12,
wherein the specified number of data strobe signals is a first number or a second number,
wherein the second number is greater than the first number, and
wherein the first number is selected when the first number is specified, and the second number is selected when the second number is specified.

15. Computer-executable process steps for causing a computer to execute the interface method of claim 12.

16. A computer-readable storage medium for storing the computer-executable process steps of claim 15.
